(19) United States
(12) Patent Application Publication
(10) Pub. No.: US 2010/0142707 A1
(43) Pub. Date: Jun. 10, 2010

(54) DATA TRANSCEIVING APPARATUS AND METHOD THEREOF

(75) Inventors: Chang-min HAN, Hwaseong-si (KR); Seung-wook HONG, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/539,013

(22) Filed: Aug. 11, 2009

(30) Foreign Application Priority Data
Dec. 5, 2008 (KR) 10-2008-0123090

(51) Int. Cl. H04L 9/00; G06F 15/16

(52) U.S. Cl. 380/255; 709/237

(57) ABSTRACT

A data transceiving apparatus includes a data communicator to set up a communication connection with a counterpart apparatus using a setup message containing encryption information, and a data processor to encrypt data transmitted to the counterpart apparatus or decrypt encrypted data received from the counterpart apparatus using the encryption information.

### CROSS-REFERENCE TO RELATED APPLICATIONS

This application claims the benefit of Korean Application No. 10-2008-0123090 filed on Dec. 5, 2008, in the Korean Intellectual Property Office, the disclosure of which is incorporated herein by reference in its entirety.

### BACKGROUND OF THE INVENTION

1. Field of the Invention

Aspects of the invention relate to a data transceiving apparatus and a method thereof, and more particularly, to a data transceiving apparatus to perform encryption or decryption using a setup message containing encryption information so that security may be maintained, and a method thereof.

2. Description of the Related Art

When a user transmits or receives data on a network using the Internet Protocol (IP), there is a possibility that the data may be exposed to other users, undermining the reliability of security maintenance. Accordingly, various encryption and decryption methods have been implemented by which a transmitter encrypts data and transmits the encrypted data to a receiver, and the receiver then decrypts the received data using an encryption key so that the data cannot be read by anyone else.

However, the encryption key is typically transmitted through a route such as e-mail, which is inconvenient for users. In light of this, the applicants have recognized that there is a need for methods by which a user may transmit data with ease and convenience.

### SUMMARY OF THE INVENTION

Aspects of the invention relate to a data transceiving apparatus to perform encryption or decryption using a setup message containing encryption information so that security may be maintained, and a method thereof.

According to an aspect of the invention, a data transceiving method of a data transceiving includes transmitting a setup message containing encryption information to a counterpart apparatus; receiving from the counterpart apparatus a response containing information on an ability of the counterpart apparatus to support encrypted communication; determining whether or not the counterpart apparatus is able to support encrypted communication based on the response; encrypting data to be transmitted to the counterpart apparatus using the encryption information upon determining that the counterpart apparatus is able to support encrypted communication; and transmitting the encrypted data to the counterpart apparatus.

According to an aspect of the invention, the data transceiving method further includes receiving information on whether or not encryption is to be used in transmitting the data to the counterpart apparatus; wherein the encrypting of the data includes encrypting the data according to the information on whether or not encryption is to be used in transmitting the data to the counterpart apparatus.

According to an aspect of the invention, the encryption information is contained in the setup message in a nonstandard data field (NSF).

According to an aspect of the invention, the data transceiving method further includes transmitting the data to the counterpart apparatus as non-encrypted data upon determining that the counterpart apparatus is unable to support encrypted communication.

According to an aspect of the invention, the data transceiving method further includes displaying a notification that encrypted communication is being performed or non-encrypted communication is being performed according to whether the data is being transmitted to the counterpart apparatus as the encrypted data or the non-encrypted data.

According to an aspect of the invention, a data transceiving method of a data transceiving includes receiving a setup message containing encryption information from a counterpart apparatus; reading out the encryption information from the setup message and storing the read encryption information; transmitting a response containing information on an ability of the data transceiving apparatus to support encrypted communication to the counterpart apparatus, and completing a setup of a communication connection with the counterpart apparatus; receiving encrypted data from the counterpart apparatus; and decrypting the received data using the stored encryption information.

According to an aspect of the invention, the encryption information is contained in the setup message in a nonstandard data field (NSF).

According to an aspect of the invention, the data transceiving method further includes displaying notification that encrypted communication is being performed or non-encrypted communication is being performed according to the ability of the data transceiving apparatus to support encrypted communication.

According to an aspect of the invention, a data transceiving apparatus includes a data communicator to set up a communication connection with a counterpart apparatus using a setup message containing encryption information; and a data processor to encrypt data to be transmitted to the counterpart apparatus using the encryption information, transmit the encrypted data to the counterpart apparatus through the communication connection, and decrypt encrypted data received from the counterpart apparatus using the encryption information.

According to an aspect of the invention, the data processor determines whether or not the counterpart apparatus is able to support encrypted communication, and upon determining that the counterpart apparatus is able to support encrypted communication, the data processor encrypts the data.

According to an aspect of the invention, the data transceiving apparatus further includes an input unit to receive input information containing information regarding the counterpart apparatus and information on whether or not encryption is to be used in transmitting the data to the counterpart apparatus; wherein when the input unit receives the input information, containing the information regarding the counterpart apparatus, the data communicator transmits the setup message containing the encryption information to the counterpart apparatus and sets up the communication connection with the counterpart apparatus, and the data processor encrypts the data to be transmitted to the counterpart apparatus according to the information on whether or not encryption is to be used in transmitting the data to the counterpart apparatus.

According to an aspect of the invention, the encryption information is contained in the setup message in a nonstandard data field (NSF).

According to an aspect of the invention, the data transceiving apparatus further includes a storage unit to store the encryption information; wherein when the setup message is received from the counterpart apparatus, the data communicator reads out the encryption information from the setup message, stores the read encryption information in the storage unit, transmits a response containing information on an ability of the data transceiving apparatus to support encrypted communication to the counterpart apparatus, and completes the setup of the communication connection with the counterpart apparatus.

According to an aspect of the invention, upon determining that the counterpart apparatus is unable to support encrypted communication, the data processor does not encrypt the data to be transmitted to the counterpart apparatus, and the data communicator transmits the non-encrypted data to the counterpart apparatus.

According to an aspect of the invention, the data transceiving apparatus further includes a display unit to display a notification that encrypted communication is being performed or non-encrypted communication is being performed according to whether the data is being transmitted to the counterpart apparatus as the encrypted data or the non-encrypted data.

According to an aspect of the invention, the setup message is defined by an H.323 protocol or a session initiation protocol (SIP).

According to an aspect of the invention, a data transceiving apparatus includes a data communicator to transmit a setup message containing encryption information to a counterpart apparatus, and receive a response to the setup message from the counterpart apparatus, the response containing information on an ability of the counterpart apparatus to support encrypted communication; and a data processor to determine whether or not the counterpart apparatus can support encrypted communication based on the response to the setup message, encrypt data to be transmitted to the counterpart apparatus when the data processor determines that the counterpart apparatus can support encrypted communication, and not encrypt the data to be transmitted to the counterpart apparatus if the data processor determines that the counterpart apparatus cannot support encrypted communication; wherein the data communicator transmits the encrypted data to the counterpart apparatus when the data processor encrypts the data to be transmitted to the counterpart apparatus, and transmits the non-encrypted data to the counterpart apparatus when the data processor does not encrypt the data to be transmitted to the counterpart apparatus.

Additional aspects and/or advantages of the invention will be set forth in part in the description that follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings of which:

FIG. 1 shows a first data transceiving apparatus and a second data transceiving apparatus connected to each other via a network according to an aspect of the invention;

FIG. 2 is a block diagram of the first data transceiving apparatus and the second data transceiving apparatus in FIG. 1 according to an aspect of the invention;

FIG. 3 is a flowchart of a data transmitting process according to an aspect of the invention;

FIG. 4 is a flowchart of a data receiving process according to an aspect of the invention; and

FIG. 5 shows a screen of a data transceiving apparatus according to an aspect of the invention.

### DETAILED DESCRIPTION OF THE EMBODIMENTS

Reference will now be made in detail to embodiments of the invention, examples of which are shown in the accompanying drawings, wherein like reference numerals refer to like elements throughout. The embodiments are described below in order to explain aspects of the invention by referring to the figures.

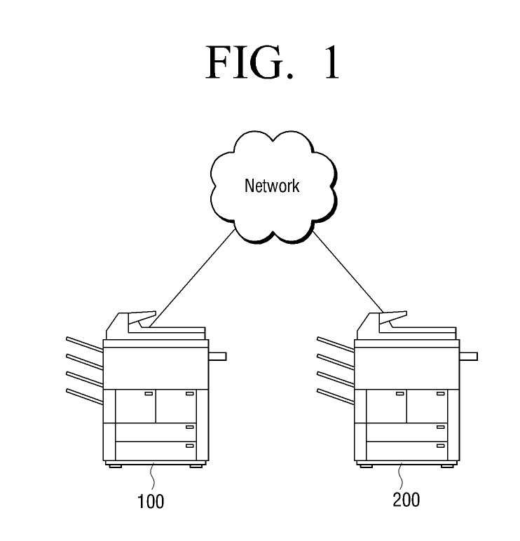

FIG. 1 shows a first data transceiving apparatus 100 and a second data transceiving apparatus 200 connected to each other via a network according to an aspect of the invention. In FIG. 1, the first and second data transceiving apparatuses 100 and 200 are connected to each other via the network in order to transceive (i.e., send and receive) data, and may be configured in a print system including a facsimile machine to transceive facsimile (fax) data using an Internet protocol (IP), a host device to transceive print data, and a printing device. Additionally, the first and second data transceiving apparatuses 100 and 200 in FIG. 1 may be implemented as a plurality of image forming apparatuses capable of performing IP-FAX communication.

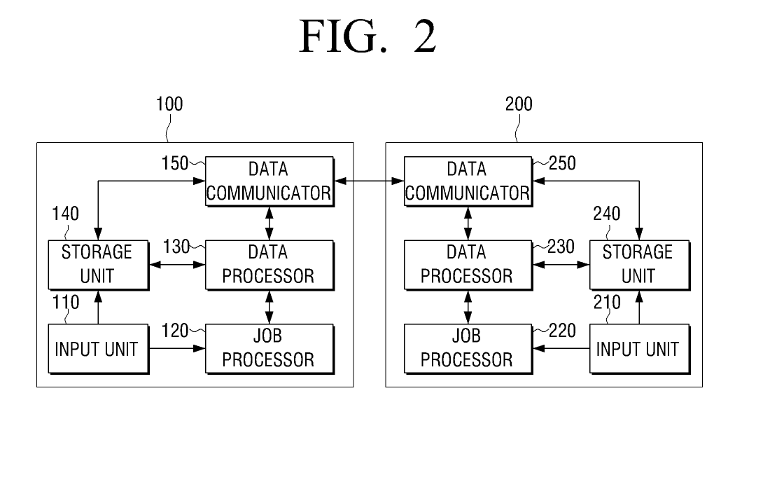

A facsimile machine to transceive fax data will now be described as an example of a data transceiving apparatus according to an aspect of the invention. The first and second data transceiving apparatuses 100 and 200 in FIG. 1 may be configured as shown in FIG. 2.

FIG. 2 is a block diagram of the first and second data transceiving apparatuses 100 and 200 in FIG. 1. In FIG. 2, the first data transceiving apparatus 100 includes an input unit 110, a job processor 120, a data processor 130, a storage unit 140, and a data communicator 150. The first data transceiving apparatus 100 is connected to a counterpart apparatus, namely the second data transceiving apparatus 200, via the network in order to transmit data to or receive data from the counterpart apparatus. The second data transceiving apparatus 200 has the same configuration as the first data transceiving apparatus 100. That is, the second data transceiving apparatus 200 includes an input unit 210, a job processor 220, a data processor 230, a storage unit 240, and a data communicator 250. Additionally, the first data transceiving apparatus 100 and the second data transceiving apparatus 200 may perform substantially the same function.

A process by which the first data transceiving apparatus 100 encrypts fax data and transmits the encrypted fax data to the second data transceiving apparatus 200, and the second data transceiving apparatus 200 receives the encrypted fax data and decrypts the received fax data to output the decrypted data, will now described with reference to FIG. 2.

The input unit 110 receives an input of a fax transmission command and information on whether or not encryption is to be used, that is, whether the fax data is to be encrypted. More specifically, in response to the information on whether or not encryption is to be used, that is, whether the fax data is to be encrypted, the input unit 110 receives an input of unique user information including a user password or user identification (ID) or the like, so that encrypted communication may be performed using the unique user information.

When the user enters the fax transmission command to the input unit 110, the user also enters input information containing information regarding the counterpart apparatus, namely the second data transceiving apparatus 200. The input information may include an IP address, a fax number of the second data transceiving apparatus 200, or any other information identifying the second data transceiving apparatus 200.

The job processor 120 scans a document in response to the fax transmission command received by the input unit 110 to obtain scanned data, and transmits the scanned data to the data processor 130.

The storage unit 140 stores the input information received by the input unit 110, encryption information, and unique information regarding the first data transceiving apparatus 100, for example, a name of a manufacturer, an ID, and a serial number of the first data transceiving apparatus 100. The encryption information may include an encryption key and a flag indicating whether or not encryption is to be used. Additionally, the storage unit 140 may store an encryption table to generate an encryption key. Values in the encryption table may be created by an administrator or may be set randomly.

In response to the input information received by the input unit 110, the data communicator 150 transmits a setup message containing the encryption information stored in the storage unit 140 to the second data transceiving apparatus 200, and sets up a communication connection.

More specifically, the data communicator 150 generates a setup message based on an H.323 protocol or a session initiation protocol (SIP), and adds the encryption information to the generated setup message using a nonstandard data field (NSF). The encryption information may include an encryption key and a flag indicating whether or not encryption is to be used, as described above. The data communicator 150 transmits the setup message containing the encryption information to the second data transceiving apparatus 200.

As described above, the H.323 protocol or the SIP may be used to transmit the setup message. After setup is completed, the data communicator 150 may transmit or receive a variety of multimedia data to or from the second data transceiving apparatus 200 using protocols other than those described above, such as fax data, telephone data, still image data, or moving image data.

When receiving a response to the setup message from the second data transceiving apparatus 200, the data communicator 150 sets up a channel between the first data transceiving apparatus 100 and the second data transceiving apparatus 200 so that the first data transceiving apparatus 100 is connected to the second data transceiving apparatus 200 through the channel. Information regarding the second data transceiving apparatus 200 contained in the response received from the second data transceiving apparatus 200 is stored in the storage unit 140. The received response may include information on the ability of the second data transceiving apparatus 200 to support encrypted communication, that is, data indicating whether or not the second data transceiving apparatus 200 supports encrypted communication. If the second data transceiving apparatus 200 is able to support encrypted communication, decryption may also be performed.

The data processor 130 encrypts and decrypts data. More specifically, when channel setup is completed, the data processor 130 of the first data transceiving apparatus 100 operating as a transmitter encrypts data according to whether or not encryption is to be used, and transmits the encrypted data to the data communicator 150. If the encryption information input through the input unit 110 indicates that encryption is to be used, the data processor 130 encrypts the scanned data using the encryption key and the encryption table stored in the storage unit 140. The encryption may be performed using ARIA (Academy, Research Institute, and Agency), TDEA (Triple Data Encryption), SEED (developed by the Korea Information Security Agency), and AES (Advanced Encryption Standard) symmetric-key algorithms, all of which are well known, so no further description is provided, or any other suitable encryption algorithm.

Furthermore, if the encryption information input through the input unit 110 indicates that encryption is to be used, the data processor 130 determines whether or not to perform encryption according to the information on the ability of the second data transceiving apparatus 200 to support encrypted communication contained in the response received from the second data transceiving apparatus 200. If encrypted communication is not supported by the second data transceiving apparatus 200, encryption is not performed even though the encryption information input through the input unit 110 indicates that encryption is to be used since it would be impossible for the second data transceiving apparatus 200 to decrypt the encrypted data. Accordingly, non-encrypted data is transmitted between the first data transceiving apparatus 100 and the second data transceiving apparatus 200.

More specifically, if encrypted communication is supported by the second data transceiving apparatus 200, the data processor 130 encrypts the scanned data output the job processor 120 and transmits the encrypted data to the second transceiving apparatus 200 through the data communicator 150. Alternatively, if encrypted communication is not supported by the second data transceiving apparatus 200, the data processor 130 transmits the scanned data output from the job processor 120 as non-encrypted data to the second data transceiving apparatus 200 through the data communicator 150.

The data communicator 150 transmits the encrypted data or the scanned data output from the data processor 130 to the second data transceiving apparatus 200 based on a T.38 fax communication protocol, or any other suitable communication protocol.

After receiving the setup message from the data communicator 150 of the first data transceiving apparatus 100, the data communicator 250 of the second data transceiving apparatus 200 determines whether or not the setup message contains the encryption key and the flag indicating whether or not encryption is to be used. Upon determining that the setup message contains the encryption key and the flag, the data communicator 250 reads out the encryption key and the flag from the setup message, and transmits the read encryption key and the read flag to the storage unit 240. The storage unit 240 of the second data transceiving apparatus 200 then stores the encryption key and the flag.

Additionally, the storage unit 240 stores the unique information regarding the first data transceiving apparatus 100 contained in the setup message. The storage unit 240 also stores an encryption table identical to the encryption table stored in the storage unit 140 of the first data transceiving apparatus 100.

The data communicator 250 transmits the response to the received setup message to the first data transceiving apparatus 100 using the H.323 protocol or the SIP. More specifically, the data communicator 250 adds the information regarding the second data transceiving apparatus 200 and the information on the ability of the second data transceiving apparatus 200 to support encrypted communication to the response using the nonstandard data field (NSF). Additionally, the data communicator 250 sets up a channel between the first data transceiving apparatus 100 and the second data transceiving apparatus 200 so that the first data transceiving apparatus 100 communicates with the second data transceiving apparatus 200 through the channel.

After channel setup is completed, the data communicator 250 receives fax data from the first data transceiving apparatus 100 using the T.38 protocol or any other suitable communication protocol.

If the setup message contains the encryption key, the data processor 230 decrypts the received fax data using the read encryption key and the stored encryption table, and transmits the decrypted data to the job processor 220. Alternatively, if the setup message does not contain the encryption key, the data processor 230 transmits the received fax data to the job processor 220.

The job processor 220 prints the fax data output from the data processor 230 on a sheet of paper or other print medium.

When receiving data, the first data transceiving apparatus 100 may perform the same function as the second data transceiving apparatus 200, and when transmitting data, the second data transceiving apparatus 200 may perform the same function as the first data transceiving apparatus 100. Additionally, while the first data transceiving apparatus 100 and the second data transceiving apparatus 200 are facsimile machines according to aspects of the invention, aspects of the invention are equally applicable to a situation in which the first data transceiving apparatus 100 is a host device and the second data transceiving apparatus 200 is an image forming apparatus in order to perform a printing job.

According to aspects of the invention described above, the setup message and the response may be defined by the H. 323 protocol or the SIP, but it is understood that aspects of the invention are not limited thereto, and any other suitable communication protocol may be used, such as a session description protocol (SDP). The network between the first data transceiving apparatus 100 and the second data transceiving apparatus 200 may be any suitable network, such as a telephone line or the Internet. Regardless of the network that is used, a setup message containing encryption information may be transmitted or received using various protocols; a setup of a channel may be performed; and encryption may be performed based on the setup message.

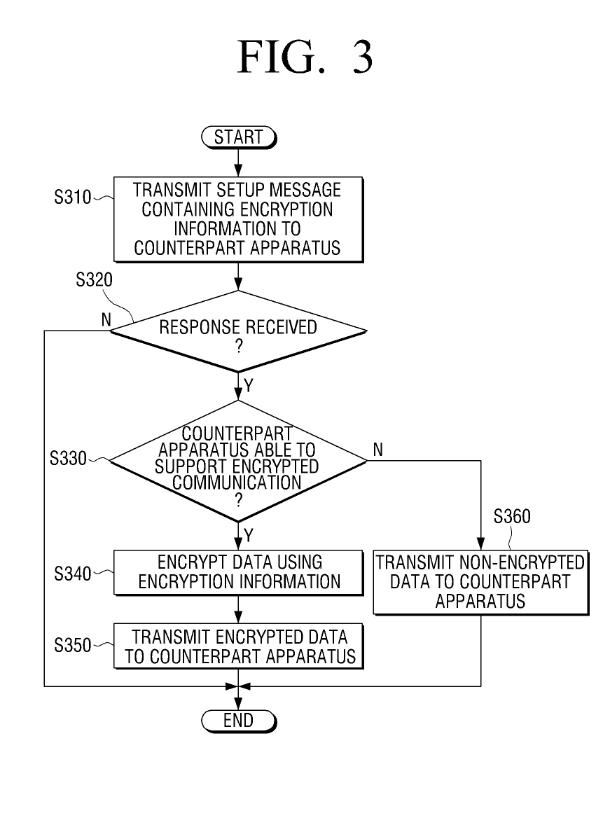

FIG. 3 is a flowchart of a data transmitting process according to an aspect of the invention. In FIG. 3, a data transceiving apparatus generates a setup message containing encryption information, and transmits the generated setup message to a counterpart apparatus in operation S310. If a response to the setup message is received in operation S320:Y, the data transceiving apparatus determines whether or not the counterpart apparatus is able to support encrypted communication in operation S330. The setup message and the response may be defined by the H.323 protocol or the SIP, or any other suitable communication protocol.

If it is determined that the counterpart apparatus is able to support encrypted communication in operation S330:Y, the data transceiving apparatus reads out the encryption information from the setup message, and encrypts data using the read encryption information in operation S340. The encryption information may include an encryption key and a flag indicating whether or not encryption is to be used.

After encryption is completed, the data transceiving apparatus transmits the encrypted data to the counterpart apparatus based on the T.38 fax communication protocol in operation S350, or based on any other suitable communication protocol.

Alternatively, if it is determined that the counterpart apparatus is unable to support encrypted communication in operation S330:N, the data transceiving apparatus transmits non-encrypted data to the counterpart apparatus in operation S360.

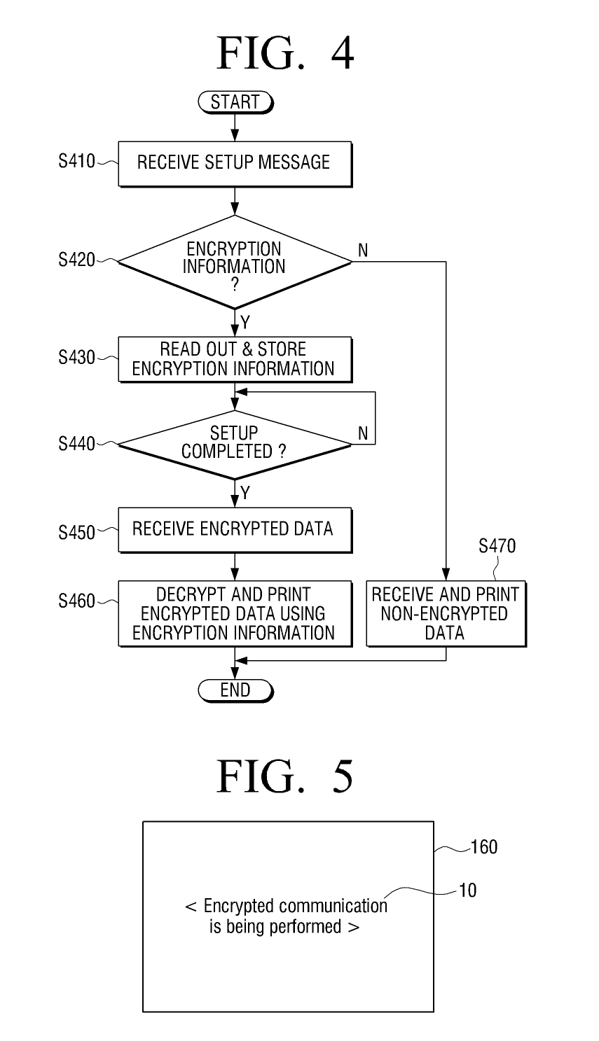

FIG. 4 is a flowchart of a data receiving process according to an aspect of the invention. In FIG. 4, after receiving the setup message from the counterpart apparatus in operation S410, the data transceiving apparatus initiates setup of a channel so that the data transceiving apparatus is connected to the counterpart apparatus through the channel.

Subsequently, the data transceiving apparatus determines whether or not the received setup message contains encryption information in operation S420. If it is determined that the setup message contains encryption information in operation S420:Y, the data transceiving apparatus reads out the encryption information from the setup message and stores the read encryption information in operation S430. Alternatively, if it is determined that the setup message does not contain encryption information in operation S420:N, the data transceiving apparatus receives and prints non-encrypted fax data received from the counterpart apparatus in operation S470.

The encryption information may include an encryption key and a flag indicating whether or not encryption is to be used.

After setup is completed in operation S440, the data transceiving apparatus receives encrypted fax data from the counterpart apparatus in operation S450. The data transceiving apparatus then decrypts and prints the received fax data using the stored encryption key in operation S460.

According to aspects of the invention, each of the first and second data transceiving apparatuses 100 and 200 may further include a display unit. Accordingly, it is possible for a user to conveniently check information on whether or not encryption is to be used or a variety of information. Additionally, when setup is currently being performed or when data is currently being encrypted, the display unit displays a current status, so it is possible for the user to easily recognize the current status.

FIG. 5 shows a screen appearing on a display unit 160 of a data transceiving apparatus according to an aspect of the invention. In FIG. 5, a message 10 stating that <Encrypted communication is being performed> is displayed on a screen of a display unit 160. The message 10 may be displayed in the center of the screen as shown in FIG. 5, or on one side of a screen displaying various basic menus. Additionally, the display unit 160 may display a notification that a setup message is being transmitted, or a response is being received, or whether encrypted communication can be used is being determined.

When the counterpart apparatus is unable to support encrypted communication, data is transmitted or received directly without being encrypted. In this situation, a message stating that non-encrypted communication is being performed may be displayed on the display unit 160. Accordingly, the display unit 160 may selectively display a message stating that encrypted communication is being performed, or a message stating that non-encrypted communication is being performed. Therefore, it is possible for a user to know exactly what the current status is.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A data transceiving method of a data transceiving apparatus, comprising:
transmitting a setup message containing encryption information to a counterpart apparatus;
receiving from the counterpart apparatus a response containing information on an ability of the counterpart apparatus to support encrypted communication;
determining whether or not the counterpart apparatus is able to support encrypted communication based on the response;
encrypting data to be transmitted to the counterpart apparatus using the encryption information upon determining that the counterpart apparatus is able to support encrypted communication; and
transmitting the encrypted data to the counterpart apparatus.

2. The data transceiving method of claim 1, further comprising receiving information on whether or not encryption is to be used in transmitting the data to the counterpart apparatus;
wherein the encrypting of the data comprises encrypting the data according to the information on whether or not encryption is to be used in transmitting the data to the counterpart apparatus.

3. The data transceiving method of claim 1, wherein the encryption information is contained in the setup message in a nonstandard data field (NSF).

4. The data transceiving method of claim 1, further comprising transmitting the data to the counterpart apparatus as non-encrypted data upon determining that the counterpart apparatus is unable to support encrypted communication.

5. The data transceiving method of claim 4, further comprising displaying a notification that encrypted communication is being performed or non-encrypted communication is being performed according to whether the data is being transmitted to the counterpart apparatus as the encrypted data or the non-encrypted data.

6. A data transceiving method of a data transceiving apparatus, comprising:
receiving a setup message containing encryption information from a counterpart apparatus;
reading out the encryption information from the setup message and storing the read encryption information;
transmitting a response containing information on an ability of the data transceiving apparatus to support encrypted communication to the counterpart apparatus, and a setup of a communication connection with the counterpart apparatus;
receiving encrypted data from the counterpart apparatus; and
decrypting the received data using the stored encryption information.

7. The data transceiving method of claim 6, wherein the encryption information is contained in the setup message in a nonstandard data field (NSF).

8. The data transceiving method of claim 6, further comprising displaying a notification that encrypted communication is being performed or non-encrypted communication is being performed according to the ability of the data transceiving apparatus to support encrypted communication.

9. A data transceiving apparatus, comprising:
a data communicator to set up a communication connection with a counterpart apparatus using a setup message containing encryption information; and
a data processor to encrypt data to be transmitted to the counterpart apparatus using the encryption information, transmit the encrypted data to the counterpart apparatus through the communication connection, and decrypt encrypted data received from the counterpart apparatus using the encryption information.

10. The data transceiving apparatus of claim 9, wherein the data processor determines whether or not the counterpart apparatus is able to support encrypted communication, and upon determining that the counterpart apparatus is able to support encrypted communication, the data processor encrypts the data to be transmitted to the counterpart apparatus.

11. The data transceiving apparatus of claim 10, wherein upon determining that the counterpart apparatus is unable to support encrypted communication, the data processor does not encrypt the data to be transmitted to the counterpart apparatus, and the data communicator transmits the non-encrypted data to the counterpart apparatus.

12. The data transceiving apparatus of claim 11, further comprising a display unit to display a notification that encrypted communication is being performed or non-encrypted communication is being performed according to whether the data is being transmitted to the counterpart apparatus as the encrypted data or the non-encrypted data.

13. The data transceiving apparatus of claim 9, further comprising an input unit to receive input information containing information regarding the counterpart apparatus, and information on whether or not encryption is to be used in transmitting the data to the counterpart apparatus;
wherein when the input unit receives the input information containing the information regarding the counterpart apparatus, the data communicator transmits the setup message containing the encryption information to the counterpart apparatus and sets up the communication connection with the counterpart apparatus, and the data processor encrypts the data to be transmitted to the counterpart apparatus according to the information on whether or not encryption is to be used in transmitting the data to the counterpart apparatus.

14. The data transceiving apparatus of claim 9, wherein the encryption information is contained in the setup message in a nonstandard data field (NSF).

15. The data transceiving apparatus of claim 9, further comprising a storage unit to store the encryption information;
wherein when the setup message is received from the counterpart apparatus, the data communicator reads out the encryption information from the setup message, stores the read encryption information in the storage unit, transmits a response containing information on an ability of the data transceiving apparatus to support encrypted communication to the counterpart apparatus, and completes the setup of the communication connection with the counterpart apparatus.

16. The data transceiving apparatus of claim 9, wherein the setup message is defined by an H.323 protocol or a session initiation protocol (SIP).

17. A data transceiving apparatus comprising:
a data communicator to transmit a setup message containing encryption information to a counterpart apparatus, and receive a response to the setup message from the counterpart apparatus, the response containing information on an ability of the counterpart apparatus to support encrypted communication; and
a data processor to determine whether or not the counterpart apparatus can support encrypted communication based on the response to the setup message, encrypt data to be transmitted to the counterpart apparatus when the data processor determines that the counterpart apparatus can support encrypted communication, and not encrypt the data to be transmitted to the counterpart apparatus if the data processor determines that the counterpart apparatus cannot support encrypted communication;
wherein the data communicator transmits the encrypted data to the counterpart apparatus when the data processor encrypts the data to be transmitted to the counterpart apparatus, and transmits the non-encrypted data to the counterpart apparatus when the data processor does not encrypt the data to be transmitted to the counterpart apparatus.

18. The data transceiving apparatus of claim 17, wherein the encryption information comprises information on whether the data to be transmitted to the counterpart apparatus is to be encrypted.

19. The data transceiving apparatus of claim 18, wherein the encryption information further comprises an encryption key to be used by the data processor in encrypting the data to be transmitted to the counterpart apparatus.

20. The data transceiving apparatus of claim 18, further comprising an input unit to receive a fax transmission command, input information containing information regarding the counterpart apparatus, and the information on whether the data to be transmitted to the counterpart apparatus is to be encrypted;
wherein:
the data communicator sets up a communication connection with the counterpart apparatus in response to the fax transmission command based on the information regarding the counterpart apparatus; and
the data processor encrypts the data to be transmitted to the counterpart apparatus when both the data processor determines that the counterpart apparatus can support encrypted communication and the information on whether the data to be transmitted to the counterpart apparatus is to be encrypted indicates that the data to be transmitted to the counterpart apparatus is to be encrypted, and does not encrypt the data to be transmitted to the counterpart apparatus when the data processor determines that the counterpart apparatus cannot support encrypted communication and/or the information on whether the data to be transmitted to the counterpart apparatus is to be encrypted indicates that the data to be transmitted to the counterpart apparatus is not to be encrypted.
